(19) United States
(12) Patent Application Publication
(10) Pub. No.: US 2026/0246249 A1
(43) Pub. Date: Aug. 20, 2026

(54) WIRE HARNESS ROUTING STRUCTURE

(71) Applicant: SUMITOMO WIRING SYSTEMS, LTD., Mie (JP)

(72) Inventor: Takashi SAKUMA, Mie (JP)

(21) Appl. No.: 19/537,127

(22) Filed: Feb. 11, 2026

(30) Foreign Application Priority Data
Feb. 18, 2025 (JP) 2025-024441

(51) Int. Cl. H02G 3/04

(52) U.S. Cl. CPC H02G 3/0468; H02G 3/0418; H02G 3/045

(57) ABSTRACT

A wire harness routing structure includes a base member constituting part of a vehicle body, a cover configured to cover at least a portion of the base member, and a wire harness drawn out from an internal space enclosed by the base member and the cover to the outside of the cover. The base member includes a support portion configured to support a wire of the wire harness in the internal space. The cover includes a through portion through which the wire is passed. The wire harness includes a stopper that is fixed to an outer circumference of the wire and configured to regulate a length of the wire to be drawn out from the through portion to the outside of the cover. The stopper is placed farther from the through portion than the support portion is within the internal space.

### CROSS-REFERENCE TO RELATED APPLICATIONS

This application is based on and claims priority from Japanese Patent Application No. 2025-024441, filed on February 18, 2025, with the Japan Patent Office, the disclosure of which is incorporated herein in its entirety by reference.

### TECHNICAL FIELD

The present disclosure relates to a wire harness routing structure.

### BACKGROUND

JP 2024-084674 A discloses a routing structure of a wire harness in a vehicle. The wire harness is routed in the vehicle while being supported by a base member constituting part of the vehicle body. For example, JP 2024-084674 A discloses a vehicle body support component for supporting the wire harness on the vehicle body. The vehicle body support component shown in FIG. 2 of JP 2024-084674 A is a clamp-shaped member formed in a substantially U-shape.

### SUMMARY

Depending on the position where the vehicle body support component is installed on the vehicle body, the vehicle body support component may be covered by a cover, and the wire harness may be drawn out from a through portion formed in the cover. In such cases, for example, when connecting a connector of the wire harness to another connector, the portion of the wire harness drawn out from the cover may be pulled. If wires are drawn out of the cover more than necessary, the drawn-out portion may interfere with the placement of other members near the cover. Therefore, it is necessary to return the excess wires drawn out of the cover back inside the cover. This operation is very cumbersome and may reduce vehicle productivity.

It is an object of the present disclosure to provide a wire harness routing structure that can limit the length of a wire harness to be drawn out from a cover.

A wire harness routing structure according to the present disclosure includes: a base member constituting part of a vehicle body; a cover configured to cover at least a portion of the base member; and a wire harness drawn out from an internal space enclosed by the base member and the cover to the outside of the cover. The base member includes a support portion configured to support a wire of the wire harness in the internal space. The cover includes a through portion through which the wire is passed. The wire harness includes a stopper that is fixed to an outer circumference of the wire and configured to regulate a length of the wire to be drawn out from the through portion to the outside of the cover. The stopper is placed farther from the through portion than the support portion is within the internal space.

According to the present disclosure, a wire harness routing structure can limit the length of a wire harness to be drawn out from a cover.

The foregoing summary is illustrative only and is not intended to be in any way limiting. In addition to the illustrative aspects, embodiments, and features described above, further aspects, embodiments, and features will become apparent by reference to the drawings and the following detailed description

### BRIEF DESCRIPTION OF THE DRAWINGS

FIG. 1 is a schematic perspective view of a wire harness routing structure according to Embodiment 1.

FIG. 2 is a cross-sectional view taken along a line II-II in FIG. 1.

FIG. 3 is a cross-sectional view taken along a line III-III in FIG. 2.

FIG. 4 is a diagram illustrating a modification of FIG. 3.

FIG. 5 is a diagram illustrating a wire harness routing structure according to Embodiment 2.

FIG. 6 is a schematic perspective view of a wire harness with a stopper according to Embodiment 3.

FIG. 7 is a schematic perspective view of a wire harness with a stopper according to Embodiment 4.

FIG. 8 is a schematic cross-sectional view of a wire harness with a stopper according to Embodiment 5.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of Present Disclosure

First, embodiments of the present disclosure will be listed and described.

A wire harness routing structure according to an embodiment includes: a base member constituting part of a vehicle body; a cover configured to cover at least a portion of the base member; and a wire harness drawn out from an internal space enclosed by the base member and the cover to the outside of the cover. The base member includes a support portion configured to support a wire of the wire harness in the internal space. The cover includes a through portion through which the wire is passed. The wire harness includes a stopper that is fixed to an outer circumference of the wire and configured to regulate a length of the wire to be drawn out from the through portion to the outside of the cover. The stopper is placed farther from the through portion than the support portion is within the internal space.

In the wire harness routing structure according to the embodiment, even when pulling the portion of the wire of the wire harness that has been drawn out from the cover, the stopper easily catches on the support portion. As a result of the stopper catching on the support portion, the wire is prevented from being drawn out from the cover by a predetermined length or more. Therefore, in the wire harness routing structure according to the embodiment, the effort required to return the wire that has been drawn out excessively from the cover back inside the cover is reduced.

In the wire harness routing structure according to the embodiment, when the drawn-out portion of the wire harness is pulled, the stopper hits against and stops at the support portion, and thus the inner circumferential surface of the cover is not strongly pressed by the stopper. Consequently, even when the drawn-out portion is pulled, the cover is less likely to detach from the base member.

In the wire harness routing structure according to the above-described feature [1], a connector of the wire harness may be connected to a rearview mirror, the base member may be a roof panel, and the cover may be a roof trim.

The drawn-out portion of the wire that extends from the through portion of the cover to the rearview mirror is visible to occupants of the vehicle. If the drawn-out portion is too long, the appearance of the interior is reduced. In the configuration including the stopper, when an operator performs an operation of connecting the connector of the wire harness to the rearview mirror, the wire is not likely to be drawn out from the cover more than necessary. This reduces the likelihood that excessively long drawn-out portion will detract the appearance of the interior.

In the wire harness routing structure according to the above-described feature [1] or [2], the support portion may have a U-shaped hook portion, and a maximum outer dimension of the wire at a position where the stopper is provided may be larger than a maximum inner dimension of the hook portion.

The maximum outer dimension is the diameter of the smallest circumscribing circle that is circumscribed about the portion of the wire where the stopper is provided when that portion including the stopper is cut in a cross-section orthogonal to the direction along the length of the wire. With the configuration of the above-described feature <3>, the stopper reliably hits against and stops at the hook portion.

In the wire harness routing structure according to the above-described feature [1] or [2], the support portion may have a C-shaped clamping portion, and a maximum outer dimension of the wire at a position where the stopper is provided may be larger than a maximum inner dimension of the clamping portion.

With the configuration of the above-described feature [4], the stopper reliably hits against and stops at the clamping portion.

In the wire harness routing structure according to any of the above-described features [1] to [4], the stopper may include a tube fitted onto the outer circumference, and tape configured to fix the tube to the outer circumference.

With the configuration of the above-described feature [5], the stopper can be easily formed on a wire of an existing wire harness by simply fitting the tube onto the outer circumference of the wire and fixing the tube to the outer circumference with the tape.

In the wire harness routing structure according to the above-described feature [5], the tube may have a first end portion near the support portion and a second end portion opposite to the first end portion, and the tape may fix the tube to the outer circumference at a position of the second end portion.

Even if the wire harness is pulled and the first end portion of the tube comes into contact with the support portion, the tape is less likely to detach. Therefore, the fixation of the tube by the tape is easily maintained, effectively preventing the wire from being drawn out from the cover.

In the wire harness routing structure according to the above-described feature [5] or [6], the tube may have an end face facing the support portion, and the end face may be a face orthogonal to a direction along a length of the tube.

When the end face of the tube is a face orthogonal to a direction along the length of the tube, the tube easily catches on the support portion. Therefore, the tube easily hits against and stops at the support portion, making it difficult for the wire to be drawn out from the cover.

In the wire harness routing structure according to any of the above-described features [1] to [5], the stopper may include a sheet wrapped around the outer circumference in a tubular shape, and tape configured to fix the sheet to the outer circumference.

With the configuration of the above-described feature [8], the stopper can be easily formed on a wire of an existing wire harness by simply wrapping the sheet onto the outer circumference of the wire and fixing the sheet to the outer circumference with the tape.

### Detail of Embodiments of Present Disclosure

Hereinafter, embodiments of a wire harness routing structure according to the present disclosure will be described with reference to the drawings. The same reference signs in the figures indicate identical members. Note that the present invention is not limited to the configurations described in the embodiments but is defined by the claims, and all changes within the meaning and scope equivalent to the claims are intended to be included.

### Embodiment 1

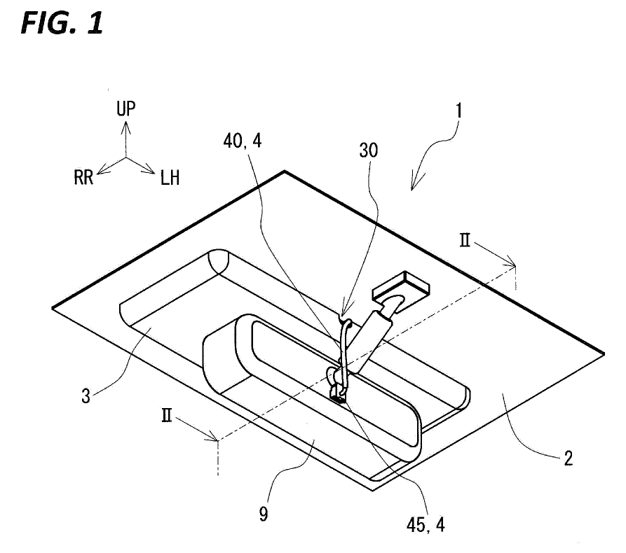

A wire harness routing structure 1 of this example shown in FIGS. 1 to 3 is positioned near a rearview mirror 9 (FIG. 1) and supplies power to the rearview mirror 9. In FIGS. 1 to 3, directions with respect to the vehicle are indicated by arrows. The RR direction is rearward of the vehicle, the LH direction is leftward of the vehicle, and the UP direction is upward of the vehicle. In the following description, the wire harness routing structure 1 is simply referred to as "routing structure 1".

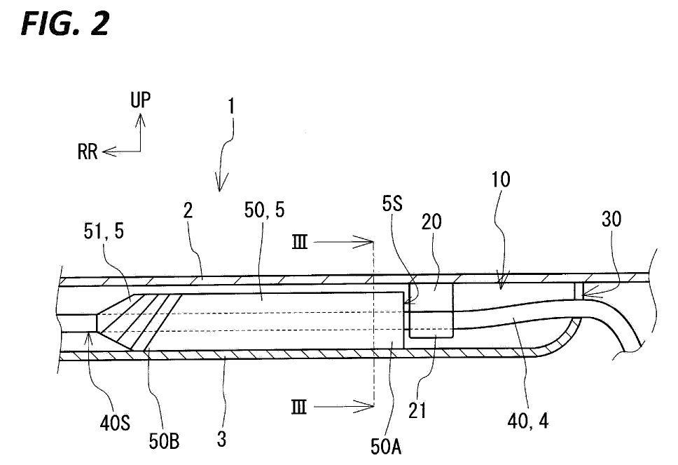

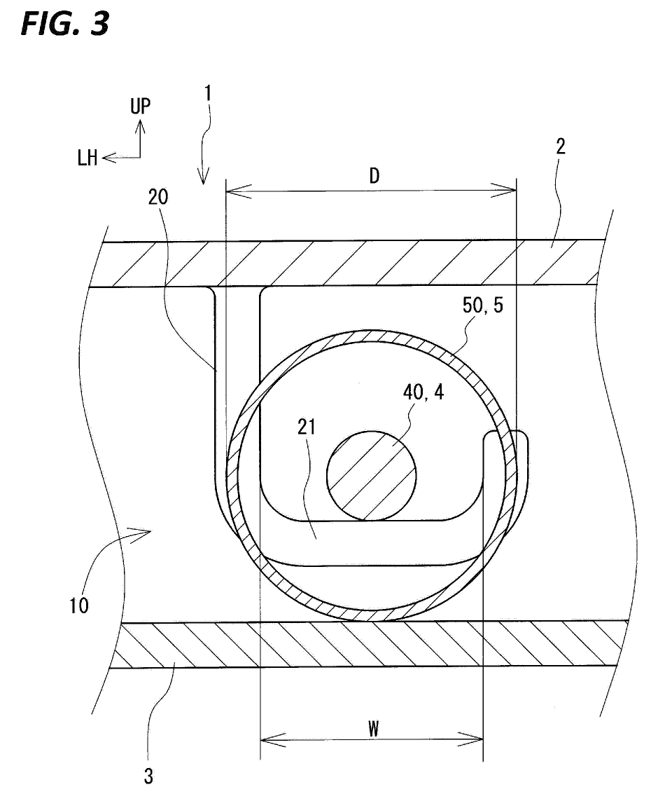

The routing structure 1 of this example includes a base member 2 constituting part of the vehicle body, a cover 3 covering at least a portion of the base member 2, and a wire harness 4 drawn out from an internal space 10 (FIGS. 2 and 3) enclosed by the base member 2 and the cover 3 to the outside of the cover 3. One feature of this routing structure 1 is that the length of a wire 40 of the wire harness 4 drawn out from the cover 3 is regulated. The following describes each of the constituent components of the routing structure 1 in order.

### Base Member

The base member 2 of this example is the roof panel of the vehicle. If the routing structure 1 is arranged at a position other than near the rearview mirror 9, the base member 2 may be, for example, the vehicle body frame. For example, the routing structure 1 may be applied to power supply to a hazard switch on the instrument panel, or may be applied to power supply to the rear door defogger.

As shown in FIGS. 2 and 3, the base member 2 includes a support portion 20 for supporting the wire 40 of the wire harness 4. The support portion 20 of this example has a U-shaped hook portion 21, as shown in FIG. 3. The overall shape of the support portion 20 is a J-shape. The wire 40 is suspended from the base member 2, which is the roof panel, by being placed inside the U-shaped hook portion 21. The outer diameter of the wire 40 is smaller than the maximum inner dimension W of the hook portion 21. The maximum inner dimension W is the maximum width of a holding space of the hook portion 21 that holds the wire 40. More specifically, the maximum inner dimension W is the length between two straight sections of the hook portion 21 that face each other. The support portion 20, which has a maximum inner dimension W larger than the outer diameter of the wire 40, supports the wire 40 to the extent that it determines the routing route of the wire 40 within the base member 2, but does not rigidly fix the wire 40 in place. Therefore, by pulling the wire 40 that has been drawn out from the cover 3, the wire 40 can further be drawn out of the cover 3.

### Cover

The cover 3 of this example is a roof trim of the vehicle. Roof trims constitute the interior. Roof trims are made of, for example, resin or the like. The wire 40 of the wire harness 4 is routed within the internal space 10 enclosed by the base member 2 and the cover 3. The cover 3 protects the wire harness 4 and ensures the appearance of the interior by concealing the wire 40 of the wire harness 4 from occupants.

As shown in FIGS. 1 and 2, the cover 3 is provided with a through portion 30. The through portion 30 is used to draw a portion of the wire harness 4 routed within the internal space 10 to the outside of the cover 3. In this example, the through portion 30 is a notch, and the cover 3 is attached to the base member 2 in a manner such that the open end of the notch faces the base member 2. Unlike this example, the through portion 30 may be a through hole that passes through the cover 3.

### Wire Harness

The wire harness 4 is a wiring member in which a plurality of wires 40 are bundled together using tape or the like. In this example, out of the plurality of wires 40, one wire 40 that has branched off is shown. The wire 40 includes a conductor and an insulation coating formed around the outer circumference of the conductor. Insulating tape or the like may further be wound around the outer circumference of the insulation coating.

A connector 45 (FIG. 1) is attached to an end of the wire 40. In this example, the connector 45 of the wire harness 4 is connected to a connector of the rearview mirror 9. In other words, the wire 40 of a predetermined length from the connector 45 is drawn out of the cover 3. When an operator connects the connector 45 to the rearview mirror 9, the operator may pull the portion of the wire 40 that has been drawn out from the cover 3. Since this drawn-out portion is visible to occupants of the vehicle, the appearance of the interior will be reduced if the drawn-out portion is too long. Therefore, in the routing structure 1 of this example, a stopper 5 (FIG. 2) is provided to make it difficult for the wire 40 to be drawn out from the cover 3 more than necessary.

### Stopper

As shown in FIG. 2, the stopper 5 cooperates with the support portion 20 provided on the base member 2 to regulate the length by which the wire 40 is drawn out from the through portion 30 to the outside of the cover 3. The stopper 5 is placed farther from the through portion 30 than the support portion 20 is within the internal space 10. Even when pulling the portion of the wire 40 that has been drawn out from the cover 3, the stopper 5 easily catches on the support portion 20. As a result of the stopper 5 catching on the support portion 20, the wire 40 is prevented from being drawn out from the cover 3 by a predetermined length or more. Therefore, in the routing structure 1 of this example, the effort required to return the wire 40 that has been drawn out excessively from the cover 3 back inside the cover 3 is reduced.

In the routing structure 1 of this example, when the drawn-out portion of the wire harness 4 is pulled, the stopper 5 hits against and stops at the support portion 20, and thus the inner circumferential surface of the cover 3 is not strongly pressed by the stopper 5. Consequently, even when the drawn-out portion is pulled, the cover 3 is less likely to detach from the base member 2.

The stopper 5 of this example includes a tube 50 fitted onto an outer circumference 40S of the wire 40 and tape 51 for fixing the tube 50 to the outer circumference 40S. With this configuration, the stopper 5 can be easily formed on a wire 40 of an existing wire harness 4 by simply fitting the tube 50 onto the outer circumference 40S of the wire 40 and fixing the tube 50 to the outer circumference 40S of the wire 40.

The tube 50 has a first end portion 50A near the support portion 20 and a second end portion 50B opposite to the first end portion 50A. The tape 51 fixes the tube 50 to the outer circumference 40S at the position of the second end portion 50B. In this case, even if the wire harness 4 is pulled and the first end portion 50A of the tube 50 comes into contact with the support portion 20, the tape 51 is less likely to detach. Therefore, the fixation of the tube 50 by the tape 51 is easily maintained, effectively preventing the wire 40 from being drawn out from the cover 3.

An end face 5S of the tube 50 of this example that faces the support portion 20 is a face orthogonal to the direction along the length of the tube 50. Such an end face 5S is likely to catch on the support portion 20 when the wire 40 is pulled toward the through portion 30. Therefore, the tube 50 easily hits against and stops at the support portion 20, making it difficult for the wire 40 to be drawn out from the cover 3.

The stopper 5 may be configured to reliably hit against and stop at the support portion 20. For example, as shown in FIG. 3, if the maximum outer dimension D of the portion of the wire 40 where the stopper 5 is provided is larger than the maximum inner dimension W of the hook portion 21, the stopper 5 will reliably hit against and stop at the hook portion 21. Here, the maximum outer dimension D of the stopper 5 is the diameter of the smallest circumscribing circle that is circumscribed about the portion of the wire 40 where the stopper 5 is provided when that portion including the stopper 5 is cut in a cross-section orthogonal to the direction along the length of the wire 40. In the configuration of this example where the tube 50 is placed on the outer circumference 40S of the wire 40, the maximum outer dimension D of the stopper 5 is equal to the outer diameter of the tube 50.

The tube 50 may be made of metal or resin. If the tube 50 is made of resin, a load is less likely to be placed on the support portion 20 when the tube 50 hits against the support portion 20. The resin may be a hard resin or a soft resin. The resin is, for example, polyvinyl chloride.

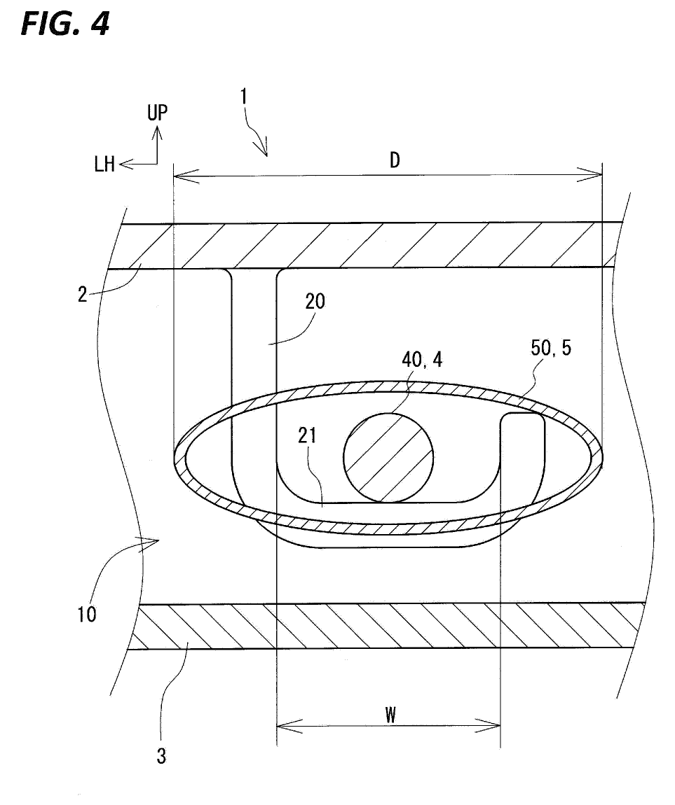

The tube 50 may have plastic deformability so as to be able to be flattened after the tube 50 is fitted onto the outer circumference 40S of the wire 40, as shown in FIG. 4. In this context, the plastic deformability means a characteristic where the tube has a hardness that allows it to be deformed by humans to retain its shape after deformation. An example of such a tube 50 is the Twist Tube (product name) manufactured by the Federal-Mogul Cooperation. The Twist Tube is a self-winding type tube in which a sheet material is rolled into a tubular shape. Since the Twist Tube can be wound around the outer circumference 40S of the wire 40 from a side of the wire 40, the tube 50 can be easily formed. If the tube 50 is flattened, the tube 50 is less likely to come into contact with the inner circumferential surface of the cover 3 even when the wire 40 is pulled during connection to the connector 45, making less likely to place a load on the mounting portion of the cover 3 with respect to the base member 2. For the tube 50 that can be flattened, it is sufficient that the maximum outer dimension D after flattening is larger than the maximum inner dimension W of the hook portion 21.

### Embodiment 2

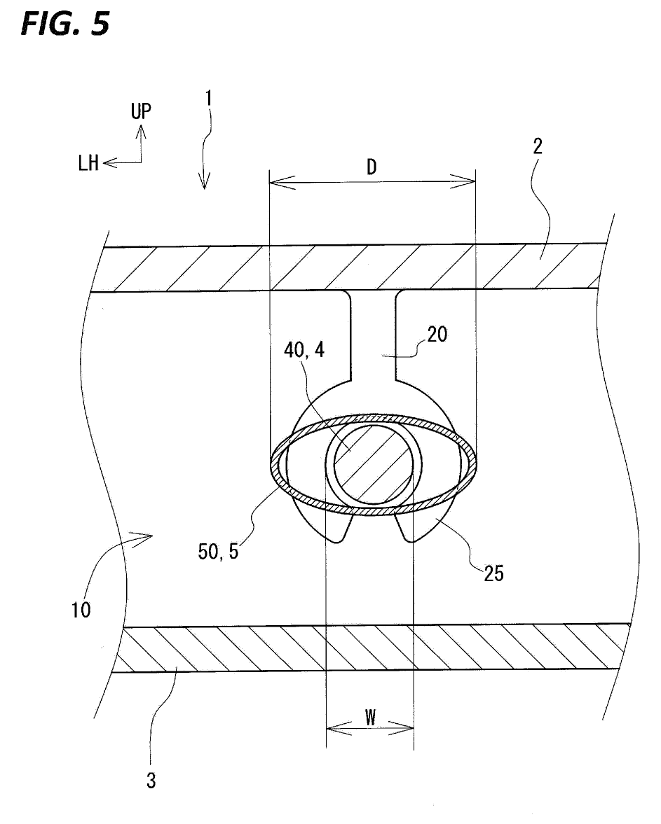

Embodiment 2 describes a routing structure 1 that differs from that in Embodiment 1 in the shape of the support portion 20 that supports the wire 40, with reference to FIG. 5. The view of FIG. 5 is the same as those of FIGS. 3 and 4 in Embodiment 1.

In the routing structure 1 of Embodiment 2, the support portion 20 has a C-shaped clamping portion 25. The opening of the C-shape of the clamping portion 25 faces downward. The width of the opening of the C-shape of the clamping portion 25 is smaller than the outer diameter of the wire 40. The clamping portion 25 is elastically deformable and is made of, for example, resin. When placing the wire 40 in the clamping portion 25, the opening of the C-shape can be widened by elastically deforming the clamping portion 25, and the wire 40 can be fitted into the widened opening. After the wire 40 is fitted into the clamping portion 25, the width of the opening becomes smaller than the outer diameter of the wire 40.

The stopper 5 of this example is provided with a flattened tube 50. The maximum outer dimension D of the tube 50 is larger than the maximum inner dimension W of the clamping portion 25. The maximum inner dimension W of the clamping portion 25 is the maximum distance between one arc portion and the other arc portion that form the C-shape. Therefore, even in the configuration of this example, the stopper 5 reliably hits against and stops at the support portion 20. The configuration of this example also allows limiting the drawn-out length of the wire 40 from the cover 3 (FIG. 1).

### Embodiment 3

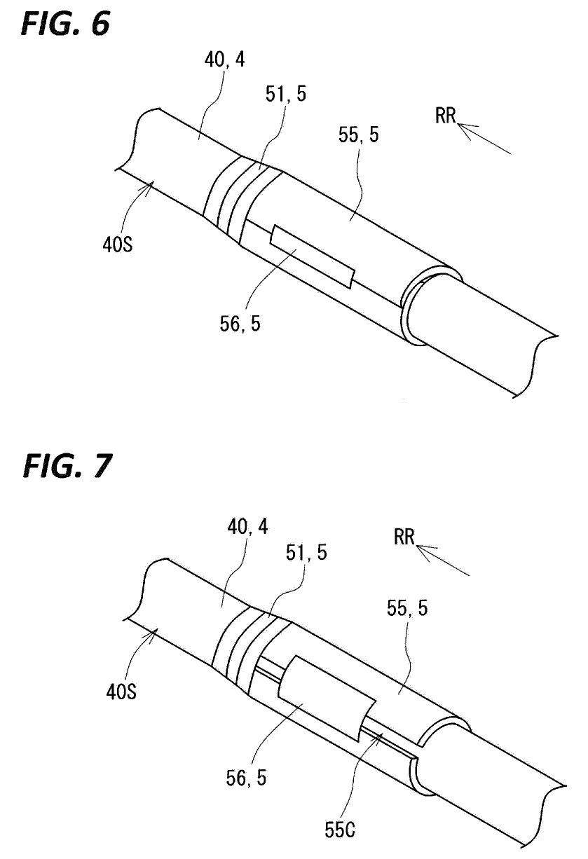

Embodiment 3 describes a routing structure that differs from those in Embodiments 1 and 2 in the configuration of the stopper 5, with reference to FIG. 6. FIG. 6 only shows a portion of the wire 40 and the stopper 5.

The stopper 5 of this example is formed by wrapping a sheet 55 around the outer circumference 40S of the wire 40 in a tubular shape. The sheet 55 is wrapped around the outer circumference 40S at least once. The sheet 55 is fixed to the outer circumference 40S by the tape 51. Since the sheet 55 can be wrapped around the outer circumference 40S of the wire 40 from a side of the wire 40, the stopper 5 can be easily formed. The stopper 5 may further include tape 56 to maintain the tubular shape of the sheet 55. The tape 56 is affixed to span both an end portion of the wrapped sheet 55 that is positioned at the outermost circumference and a portion of the outer circumferential surface of the sheet 55 that is located near that end portion.

### Embodiment 4

Embodiment 4 describes a routing structure that differs from that in Embodiment 3 in the wrapping state of the sheet 55 constituting the stopper 5, with reference to FIG. 7. The view of FIG. 7 is the same as that of FIG. 6.

The sheet 55 constituting the stopper 5 of this example only covers less than one complete outer circumference 40S of the wire 40. In other words, a gap 55C is formed where the wire 40 is exposed from the sheet 55 and not covered by the sheet 55, in the portion of the wire 40 where the sheet 55 is wrapped. The gap 55C extends in the direction along the length of the wire 40. The tape 56 is affixed to the sheet 55 so as to connect one end and the other end of the sheet 55 with the gap 55C interposed therebetween.

### Embodiment 5

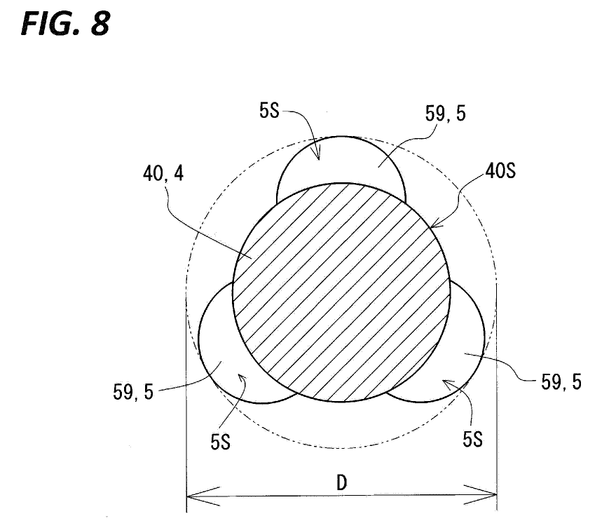

Embodiment 5 describes the stopper 5 with protruding members 59 formed on the outer circumference 40S of the wire 40, with reference to FIG. 8. FIG. 8 is a cross-sectional view of the wire harness 4 obtained by cutting the wire 40 near the protruding members 59.

The protruding members 59 of this example are bonded to the outer circumference 40S. The protruding members 59 may be formed by applying molten resin to the outer circumference 40S, or protruding members 59 prepared in advance may be bonded to the outer circumference 40S using an adhesive.

Each of the protruding members 59 of this example has a substantially semicircular shape when viewed in the direction along the length of the wire 40. The three-dimensional shape of the protruding member 59 is semi-cylindrical, and the protruding member 59 has an end face 5S orthogonal to the direction along the length of the protruding member 59. Therefore, the protruding member 59 is likely to catch on the support portion 20. The three-dimensional shape of the protruding member 59 may be, for example, hemispherical. The protruding members 59 need only have a shape that easily catches on the support portion 20 (FIG. 2 or the like). The shape of the protruding members 59 as viewed in the direction along the length of the wire 40 is not particularly limited. For example, the shape of the protruding members 59 may be substantially rectangular.

The number of protruding members 59 in this example is three. The number of protruding members 59 is not particularly limited, and may be one, two, or more than three. In this example, the maximum outer dimension D is the diameter of the smallest circumscribing circle that is circumscribed about the three protruding members 59.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A wire harness routing structure comprising:
a base member constituting part of a vehicle body;
a cover configured to cover at least a portion of the base member; and
a wire harness drawn out from an internal space enclosed by the base member and the cover to the outside of the cover,
wherein the base member includes a support portion configured to support a wire of the wire harness in the internal space,
the cover includes a through portion through which the wire is passed,
the wire harness includes a stopper that is fixed to an outer circumference of the wire and configured to regulate a length of the wire to be drawn out from the through portion to the outside of the cover, and
the stopper is placed farther from the through portion than the support portion is within the internal space.

2. The wire harness routing structure according to claim 1,
wherein a connector of the wire harness is connected to a rearview mirror,
the base member is a roof panel, and
the cover is a roof trim.

3. The wire harness routing structure according to claim 1,
wherein the support portion has a U-shaped hook portion, and
a maximum outer dimension of the wire at a position where the stopper is provided is larger than a maximum inner dimension of the hook portion.

4. The wire harness routing structure according to claim 1,
wherein the support portion has a C-shaped clamping portion, and
a maximum outer dimension of the wire at a position where the stopper is provided is larger than a maximum inner dimension of the clamping portion.

5. The wire harness routing structure according to claim 1,
wherein the stopper includes a tube fitted onto the outer circumference, and tape configured to fix the tube to the outer circumference.

6. The wire harness routing structure according to claim 5,
wherein the tube has a first end portion near the support portion and a second end portion opposite to the first end portion, and
the tape fixes the tube to the outer circumference at a position of the second end portion.

7. The wire harness routing structure according to claim 5,
wherein the tube has an end face facing the support portion, and
the end face is a face orthogonal to a direction along a length of the tube.

8. The wire harness routing structure according to claim 1,
wherein the stopper includes a sheet wrapped around the outer circumference in a tubular shape, and tape configured to fix the sheet to the outer circumference.
